(19) United States
(12) Patent Application Publication
(10) Pub. No.: US 2016/0238099 A1
(43) Pub. Date: Aug. 18, 2016

(54) Advanced Omnidirectional Impact Absorber

(71) Applicants: Scott Victor Perino, Pasadena, CA (US); Javid Bayandor, Blacksburg, VA (US)

(72) Inventors: Scott Victor Perino, Pasadena, CA (US); Javid Bayandor, Blacksburg, VA (US)

(21) Appl. No.: 15/043,284

(22) Filed: Feb. 12, 2016

Related U.S. Application Data
(60) Provisional application No. 62/115,172, filed on Feb. 12, 2015.

(51) Int. Cl. F16F 7/12; A42B 3/14

(52) U.S. Cl. CPC F16F 7/12; A42B 3/14

(57) ABSTRACT

An energy absorber comprising a first housing defining an interior space and a second housing disposed in the interior space. Also provide are a plurality of cords connecting the housing together. The cords are adapted to deform when said energy absorber undergoes an impact. The deformation permits the second housing to travel from a pre-impact position to a post-impact position within the interior space for a predetermined stroke length.

### RELATED APPLICATIONS

This application claims the benefit of U.S. Provisional Application No. 62/115,172 filed Feb. 12, 2015 and herein incorporated by reference.

### STATEMENT REGARDING FEDERALLY SPONSORED RESEARCH & DEVELOPMENT

This invention was made with government support under contract VT-03-01 awarded by National Aeronautics and Space Administration. The Government has certain rights in the invention.

### INCORPORATION BY REFERENCE OF MATERIAL SUBMITTED ON A COMPACT DISC

Not applicable.

### BACKGROUND OF THE INVENTION

The goal of any impact absorber or energy absorber (EA) is to protect an object such as a person or payload from injury or damage. During an unprotected impact, large forces are transferred to the object which may cause damage. Impact energy absorbers attempt to prevent damage by spreading out the impact event over a longer period of time and space thereby reducing the peak force experienced by the object. Typically, impact absorbers such as motorsport helmets and car bodies achieve this goal through the sacrificial destruction of the energy absorber (EA) through crush and plastic deformation mechanisms.

Omnidirectional impact protection is important because when a payload to be protected such as a payload in an Earth Entry Vehicle (EEV) is descending through the atmosphere, even with a stable aerodynamic design, there is still a probability that a gust of wind or other perturbation will rotate the vehicle to any possible and unexpected impact-orientation. If this were to happen, the samples or payload would still need to be protected and contained. Peak acceleration is important for payloads to survive an impact undamaged. Peak crush is important because there is limited space inside an EA such as the EEV for the payload. Thus the amount of possible impact protection is governed by the amount of energy absorbing structure that can be placed between the payload and the impact surface. For a fixed EEV size, there exists an inverse relationship between sample volume and crushable volume. That is to say, if more or larger samples or payloads are desired, less crushable structure and less impact protection can be provided.

Moreover, most high performance EAs such as those in racecars, are well engineered to absorb impact from a single direction or a narrow range of angles and impact scenarios. Being able to predict the direction of impact significantly simplifies the design of an energy absorber and allows high performance to be achieved with relative ease. In addition, structures that are designed to perform well in one direction usually perform very poorly for impacts from other directions. Most omnidirectional energy absorbers today are found in helmets such as those used in football and motorsports. These helmets, due to human, biomechanical, and price concerns are relatively poor energy management systems.

Spherical EAs using crushable materials such as foam are particularly difficult to design for many reasons. The most demanding issue is the constantly increasing contact area. Because of the spherical shape, when a spherical EA first makes contact with the impact surface, the contact area is infinitely small. Spherical EAs such as helmets are most often constructed of relatively soft materials like crushable foam (usually expanded polystyrene (EPS)) which also have very low crush stresses on the order of 0.1-1 MPa. Because of the extremely small contact area at first contact, a very large force can be delivered through the available area to the payload early on to begin slowing it down. As the spherical EA crushes, the contact area increases and the foam is able to absorb more and more of the energy otherwise transferred to the payload. For example, throughout the impact event, at first, the contact area is nearly zero because of the spherical shape, meaning that no force will be absorbed and all the energy will be transferred to the payload, then at later times, the contact area dramatically increases until the point where typically peak crush, peak force, peak acceleration, and zero velocity all simultaneously occur on the absorber (meaning less energy to the payload). Moreover, if the initial kinetic energy is enough to crush the foam sphere into its densification region, a spike in both force and peak acceleration may detrimentally occur.

### BRIEF SUMMARY OF THE INVENTION

In one embodiment, the present invention provides an impact absorber that functions differently than typical crushable energy absorbers. Instead of relying on the crushing and compression of material, in one embodiment, the present invention primarily uses tension to plastically stretch, lengthen and/or elongate one or more cords which limit the peak force on the protected object.

In other embodiments, the present invention provides omnidirectional protection and improved crush performance over other high performance designs.

In other embodiments, the present invention provides unidirectional protection and improved crush performance over other high performance designs.

In other embodiments, the present invention uses tension rather than compression to provide performance advantages including higher initial compression stiffness, higher crush force efficiency, near 100% stroke efficiency and potentially lower weight depending on design and material choices.

In other embodiments, the present invention uses cords, cables or rods on the impact side of the payload housing or canister that compress and then buckle under compression due to their large length to width ratio. On the opposite side of impact, the cords, cables or rods begin to stretch and quite quickly begin to plastically deform. After the cords, cables or rods on the impact side buckle, their contribution to the net force is negligible. Conversely, on the tension side, because of the nearly pure-plastic (minimal strain hardening) material response of the cords, cables or rods, the net force applied to the housing or canister quickly rises to a specific limit related to the plastic stress and strain in each of the cords, cables or rods. That specific net force induces a predictable and highly desirable flat plateau shaped acceleration response at the housing or canister until it comes to rest within the cage around it.

In other embodiments of the present invention, the cords, cables or rods are pretensioned or preloaded up to near their yield strength. Thus nearly immediately upon impact, the cords, cables or rods in tension begin to deform. In a preferred embodiment, the cords, cables or rods plastically deform. The nearly flat plastic deformation character of the cords, cables or rods means that peak force transfer cannot exceed a limit determined primarily by the size of the cords, cables or rods and material selection.

In other embodiments, the present invention provides a unidirectional impact absorber which includes a stiff cylindrical shell that may be made of metallic or composite materials. A stiff rod is positioned within the cylindrical shell which also may be made of metallic or composite materials. A set of pretensioned cords connect the top lip of the outer cylinder to the base of the inner rod and a second set of pretensioned cords connect the base of the outer cylinder shell to the base of the inner rod. A static position of overlap of approximately 20% of the length of the outer cylinder may be used to promote a stable crush. A smooth friction contact surface on the inner side of the top lip of the stiff cylinder provides constant contact and a smooth sliding surface between the outer cylinder and inner rod.

In other embodiments, the present invention provides a method and device for protecting an object from an impact force. A first housing defining an interior space is provided and a second housing is located in the interior space of the first housing. A plurality of cords connects the housings together and an object to be protected is located in the second housing. The cords are tensioned to create a compressive force in said first housing. The cords are also configured to deform during impact to average out the impact forces over time to create a flat peak load. The deformation of the cords also permits the second housing to travel from a pre-impact position to a post-impact position within the interior space up to a maximum predetermined stroke length.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 is an isometric view of one embodiment of the present invention.

FIG. 2 provides a sectional view of the embodiment shown in FIG. 1.

FIG. 3 provides a dynamic FEA simulation of the embodiment shown in FIG. 1.

FIG. 4 is an acceleration plot showing the superior near square wave pulse generated by the developed energy absorber of one embodiment of the present invention.

FIG. 5 is an isometric view of another embodiment of the present invention.

FIG. 6 provides a sectional view of the embodiment shown in FIG. 5.

FIG. 7 is a close up view of the embodiment shown in FIG. 5, pre-impact.

FIG. 8 provides a sectional view of the embodiment shown in FIG. 5, post impact.

FIG. 9 is an isometric view of another embodiment of the present invention.

FIG. 10 is an isometric view of the embodiment shown in FIG. 9, with portions removed.

FIG. 11 is a bottom view of the embodiment shown in FIG. 9, pre-impact.

FIG. 12 is a bottom view of the embodiment shown in FIG. 9, post-impact.

FIG. 13 provides a sectional view of another embodiment of the present invention.

FIGS. 14A, 14B, 14C and 14D illustrate an omnidirectional crush response of an embodiment of the present invention.

FIG. 15 illustrates cage designs that may be used with various embodiments of the present invention.

FIG. 16 illustrates performance characteristics of various energy absorber designs subjected to identical impact conditions.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

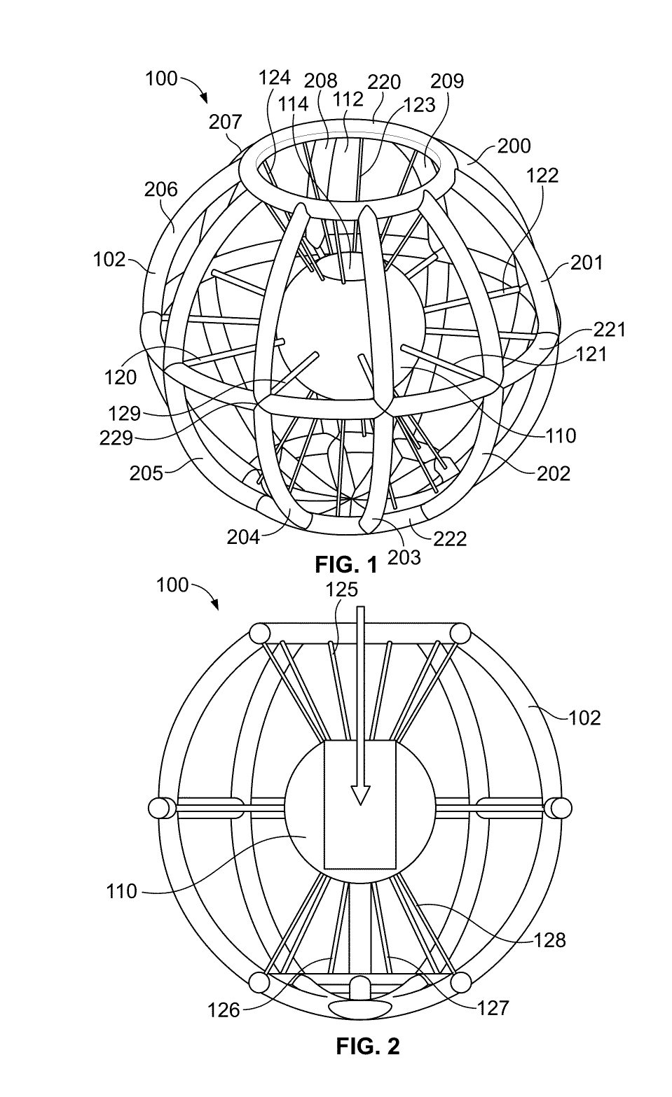

As shown in FIGS. 1 and 2, in one embodiment, the present invention provides an omnidirectional energy absorber 100 that may be used with a passive Earth Entry Vehicle (EEV) designed to be used without a parachute. Other applications include using the EA of the present invention in helmets, safe aircraft and automobile seats, train and car bumpers, elevator safety buffers, and other applications. In one preferred embodiment, a stiff spherical cage or frame 102 is provided which may be constructed of metal or a composite material. In a preferred embodiment, cage 102 may be a hoop design arranged with a plurality of interconnected vertical hoops 200-209 and horizontal hoops 220-222. The hoops may be tubular in design.

A housing 110 is located within external cage or frame 102. In a preferred embodiment, housing 110 may be a spherical canister.

One or more openings 112 and 114 allow access for loading a payload to be protected within housing 110. In a preferred embodiment, housing 110 is a spherical canister that is concentrically located within a spherical frame as shown.

A plurality of radially arranged and pretensioned cords 120-129 tightly suspend and hold housing 110 within frame 102. For ease of reference, only some of the cords shown have been numbered. The cords may also be cables, rods, and other structural components that deform under a load. In yet other embodiments, the cords may be solid rods or other solid structural components that deform under a load.

In addition, other cord arrangements may be used in accordance with the teachings of the present invention. In yet a preferred design, the cords are affixed to the outer surface of housing 110. In yet other designs, the cords are equally spaced along a substantial portion or the entire portion of housing 110.

In yet other embodiments, cords 120-129 may be affixed to cage 102 at the junctions of the vertical and horizontal hoops which may intersect at 90 degrees. FIG. 1 shows cord 129 at juncture 229.

The cords may be tightened to almost their yield stress and constructed of a material with a relatively high elastic modulus. In addition, the cords may have long and flat plastic deformation regions. In yet another embodiment, the cords may be pretensioned so as to permit the cord to function as a column or support to rigidly position the protective housing within the frame. In yet other embodiments, the present invention may use a combination of rigid and flexible cords.

In another embodiment, the pretensioned cords 120-129 put cage 102 into compression. As a result, preloaded cords 120-129, cage 102 and canister 110 form a rigid, unified structure that maintains the position of canister 110 with respect to cage 102. This positional stability, prior to impact, and even during impact, of the unified assembly, locks the payload into position which prevents damage to the payload during normal use and even after impact.

For another embodiment which may be used in EEV applications, the preload in the cords is designed to be higher than the loads during launch, robotic operations, and reentry, but not during impact. During EEV launch, and sample loading and other robotic operations, the preloaded cords create a stable and stiff position of the payload housing or canister for all operations besides the critical impact event. This provides a significant benefit for autonomous robotic operations in that the payload canister can be interfaced with easily, despite it being fully suspended.

During impact, the tensile load in the cords farthest away from the impact surface increases above static preload, and critically for the design point (go into plastic tensile extension). As for the other cords, the cords between the impact surface and the payload, go from tensile loading, down to zero load, and then simply bend (no moments are applied to cords). In embodiments in which solid rods are used on the impact side of the payload, the rods go from preload tension, through zero, then into pre-buckling compression, then into buckling, then into post buckling plastic bending.

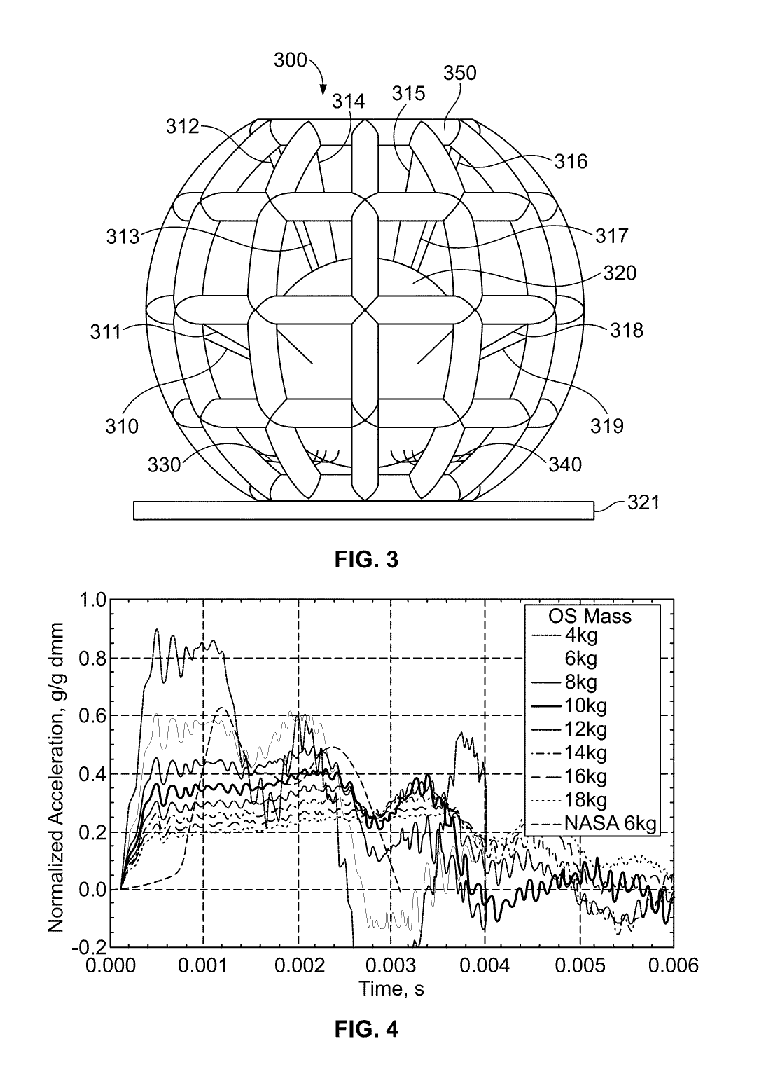

Numerical testing has proved the efficacy of the impact absorber of the present invention. One high fidelity dynamic simulation is shown in FIG. 3 where impact absorber 300 has reached zero velocity and is in its most deformed state. As shown in FIG. 3, cords 310-318 have plastically deformed and, as a result, the interior capsule 320 has displaced toward the impact surface 321 but is still well protected. In addition, cord sets 330 and 340 have collapsed as a result of no longer being under tension or by absorbing the force of the impact. As shown, the cords are configured to allow canister or capsule 320 to travel within outer cage 350 without contacting cage 350 while absorbing or neutralizing an impact.

The distance traveled by the canister relative to the cage is the stroke length and is determined by the amount of cord deformation. In a preferred embodiment, the cords may deform and increase in length by as much as 200% of their original length. For a predetermined configuring of cords, the stroke length for a given range of impact forces may be predetermined.

An impact force is transferred by utilizing the stiff frame or cage and the connected pretensioned cords. The force of the impact is transferred from the housing 320 through the cords into the frame, through the frame in compression and finally into the ground. As a result, the embodiments of the present invention, by using a well thought-out cage design and correct sizing, placement, and material selection for the cords, results in an energy absorber that can significantly outperform other energy absorbers of similar size and weight. In addition, in a preferred embodiment, the cords are periodically positioned around housing 320 in such a manner that a plurality of cords are engaged no matter the impact angle of the EA. In a preferred embodiment, the angle of at least two cords rearward of the impact point, are offset by no more than 30-60 degrees from the Y-axis extending from the impact point through the EA.

Testing indicates that for comparably sized energy absorbers, the designs of the present invention provide the same protection payloads with more than double the mass and with similar displacement safety margins. FIG. 4 shows the acceleration response of an advanced spherical impact absorber developed by NASA for the EEV vehicle compared with a numerical simulation of an impact absorber of one embodiment of the present invention with a payload double its mass. The NASA impact absorber had a payload mass of about 6 kg and the numerical simulation was 12 kg. Both payloads displace approximately 70% of the available space. Because the embodiments of the present invention can maintain a nearly ideal square wave acceleration pulse, the performance is significantly improved without increasing damaging acceleration loading on the payload.

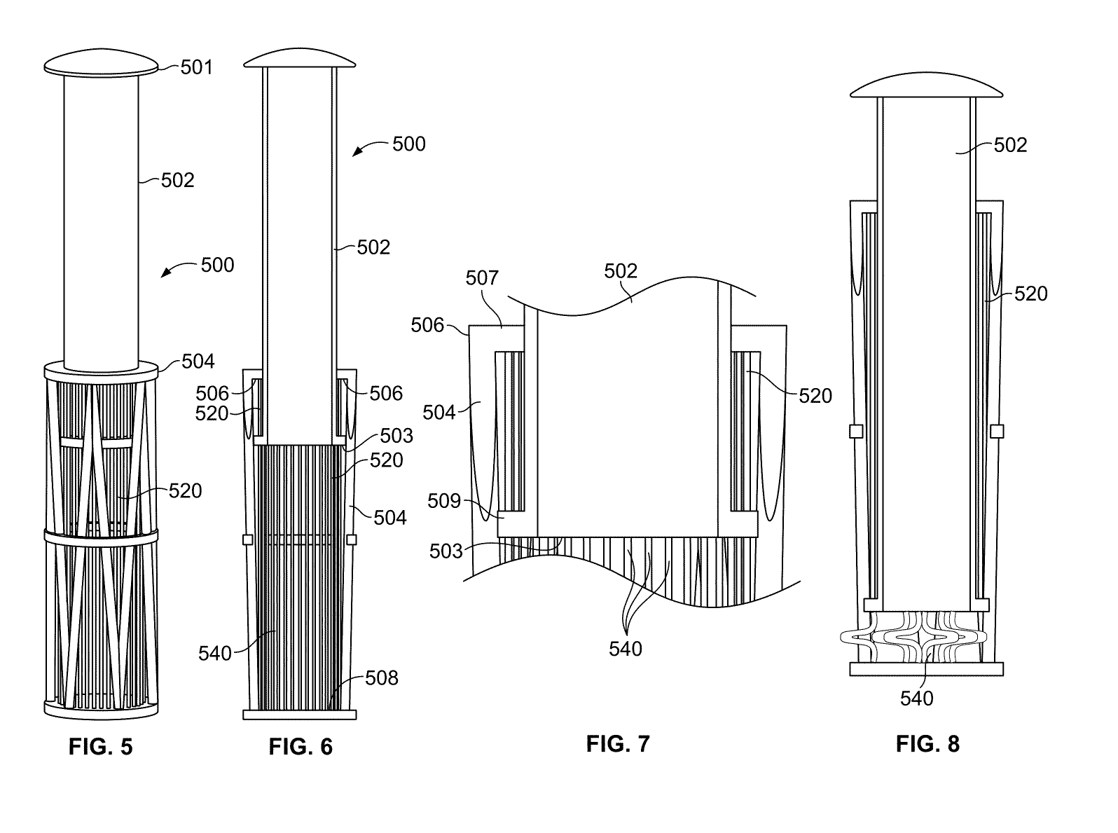

In other embodiments, the present invention provides a linear tension cord energy absorber 500 as shown in FIGS. 5-8. As shown in FIG. 5, absorber 500 includes a bumper 501 that is attached to a slider or piston 502 that seats within a base 504. Slider 502 and base 504 are adapted and configured to permit slider 502 to slide or travel into base 504 during impact. Base 504 is rigidly attached to a primary structure to which the load is transferred.

A plurality of tension cords 520 are pretensioned and may be made of a deformable material such as nylon or other materials that provide a stiff connection between the slider and base before impact and plastically deform during impact.

As shown in FIG. 6, tension cords 520 are connected at top 506 of base 504 and bottom 503 of slider 502. Another set of tension cords 540 are connected at bottom 503 of slider 502 and bottom 508 of base 504.

As shown in FIG. 7, slider 502 is laterally stabilized by configuring flange 507 of top 506 and flange 509 of bottom 503 to maintain slider 502 in a vertical position in base 504. In addition, prior to impact, cords 520 and 540 are pretensioned above and below the slider attachment area or bottom 503 such that the forces are statically equal and the slider maintains its initial position. This puts base 504 in compression which, in turn, provides positional stability prior to impact of the unified assembly.

As shown in FIG. 8, after impact, slider 502 moves into base 504 and tension cords 520 plastically stretch while cords 540 below the slider buckle, and provide minimal resistance to motion. Configuring cords 520 and 540 in this manner provides a smooth controlled force transfer to the primary support structure. In an alternate embodiment, some or all of the cords may be configured to function as deformable or crushable columns or supports that resist the impact force.

Applications for this embodiment include use as elevator safety buffers. The embodiment provides a simpler design with improved performance over current spring only designs. The design is less expensive and has lower maintenance than high performance spring-damper designs.

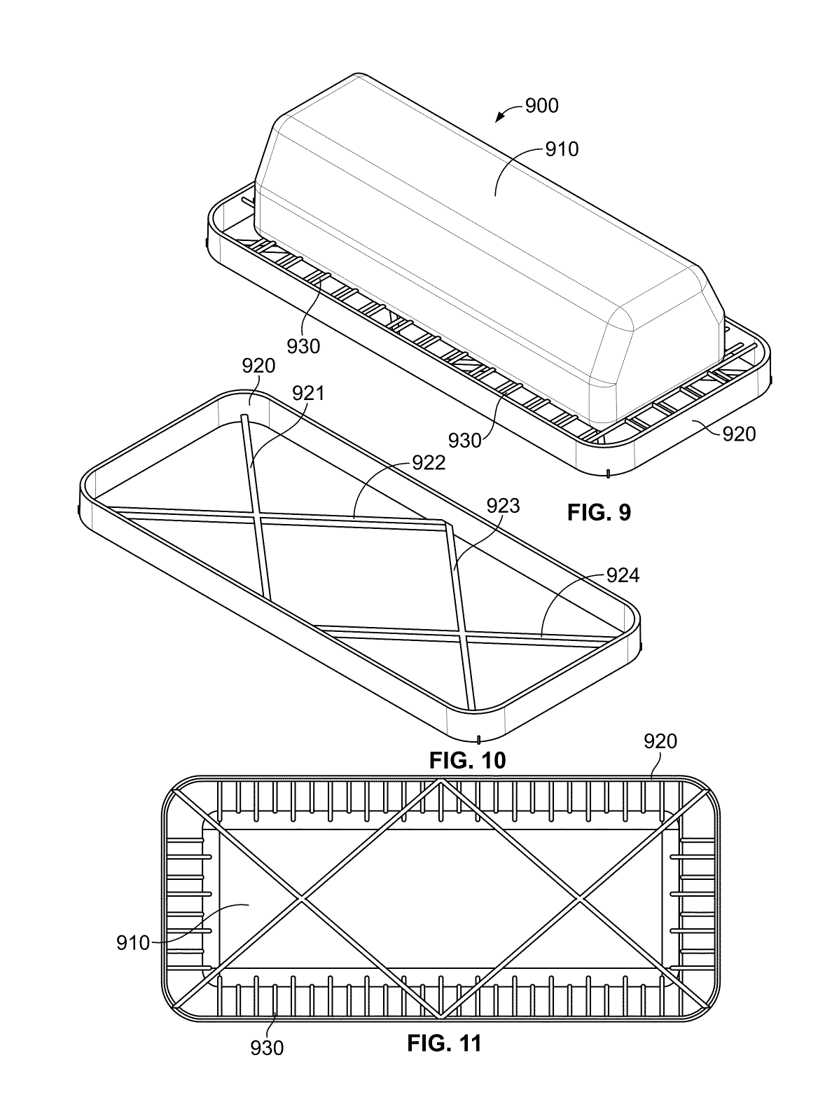

FIGS. 9-12 illustrate an embodiment of the present invention that provides unidirectional energy absorber 900 which may be used as a passenger compartment. As shown, compartment 910 is connected to bumper 920 via tension cords 930. Stiffened bumper 920 contacts with other cars or objects, and transfers any load in a controlled manner to passengers through cords 930 which are pretensioned and preferably made of nylon or other material so as to provide a stiff connection between the bumper and passenger compartment before impact and plastically deform during impact. In an alternate embodiment, some or all of the cords may be configured to function as deformable or crushable columns or supports that resist the impact force.

FIGS. 10 and 11 show how bumper 920 may be reinforced with braces 921-924. In addition, prior to impact, cords 930 are arranged around the perimeter of compartment 910 and affix the compartment to the bumper. The cords are pretensioned to put bumper 920 in compression which, in turn, provides positional stability prior to impact of the unified assembly.

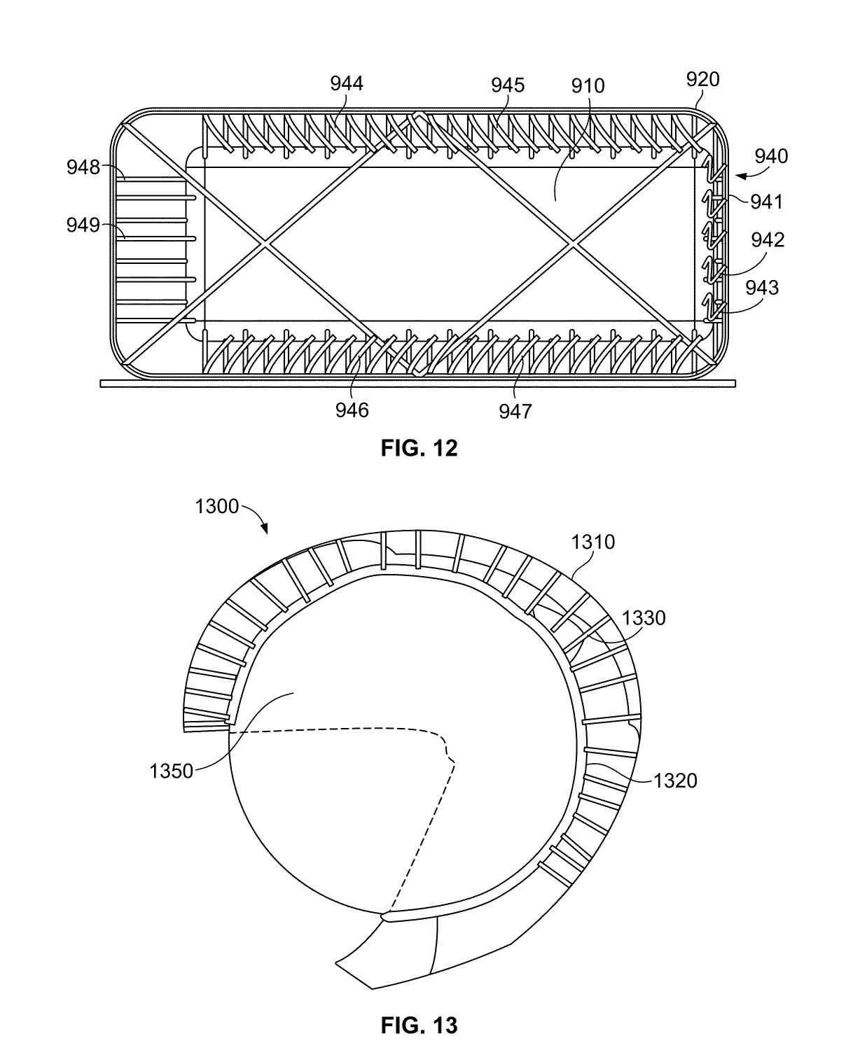

Upon impact, as shown in FIG. 12, certain cords 941-943 will buckle, other cords 944-947 will angularly stretch and other cords 947-949 will linearly stretch. The unidirectional absorber has tailorable performance for weight requirements. It has improved safety for low to medium velocity impacts. It provides low cost replacement cords for minor impacts and improved frontal and rear impact performance for vehicles.

FIG. 13 depicts another embodiment of the present invention which provides a lighter and slimmer helmet 1300. As shown, helmet 1300 includes an outer shell 1310 and inner shell 1320 with cords 1330 evenly distributed in three-dimensions throughout the gap created between the shells. During impact, outer shell 1310 transfers the load to inner shell 1320 and then head 1350. The cords limit peak impact loads on head 1350 and allow a controlled and predictable acceleration pulse on head 1350. This, in turn, decreases the risk of critical brain injury in serious head impacts. It also provides increased comfort due to better air circulation within the helmet caused by the air voids intrinsic to the design.

In addition, prior to impact, the cords are arranged around the perimeter of the inner shell and pretensioned to put shell 1310 in compression. To achieve positional stability prior to impact, and to create a unified assembly, the compressive force created by the cords should net to zero.

Other applications in which the outer shell and inner shell embodiment may be used include seat applications. Deploying this embodiment of the present invention in a seat provides improved safety via fewer spine and back injuries during survivable impacts. The design provides low or no weight increase over current seat designs. It also provides a low cost via simple aluminum parts and easily replaceable tension cords.

In another embodiment, cord arrangements may be set to be symmetric across the hemispherical mid-plane of the cage, which is the plane cutting the cage in half and parallel to the impact surface at an orientation of 0 degrees. Some cord orientations for various embodiments of the present invention are set forth below in Table 20.

TABLE 20

| 2 Hoop | 3 Hoop | 4 Hoop |
|---|---|---|
| 0°-180° | 0°-90°-180° | 0°-45°-135-180° |
| 15°-165° | 15°-90°-165° | 15°-65°-115°-165° |
| 30°-150° | 30°-90°-150° | 30°-70°-110°-150° |
| 45°-135° | 45°-90°-135° | 45°-75°-105°-135° |
| 60°-120° | 60°-90°-120° | 60°-80°-100°-120° |
| 75°-105° | 75°-90°-105° | 75°-85°-95°-105° |
| 90°-90° | 90°-90°-90° | 90°-90°-90°-90° |

Impact-orientations from 0-90 degrees were simulated every 5 degrees for each cord orientation. Neglecting the opening on the top of the hoop-ring cage, the cage and cord are symmetric across all three orthogonal planes centered at the center of the cage. The maximum peak acceleration variation determined for the deformable cage simulation conducted was 1.7%. Given the very small variation in response for axial cage rotations the cage is considered quasi-axisymmetric for configurations with 12 cords or more.

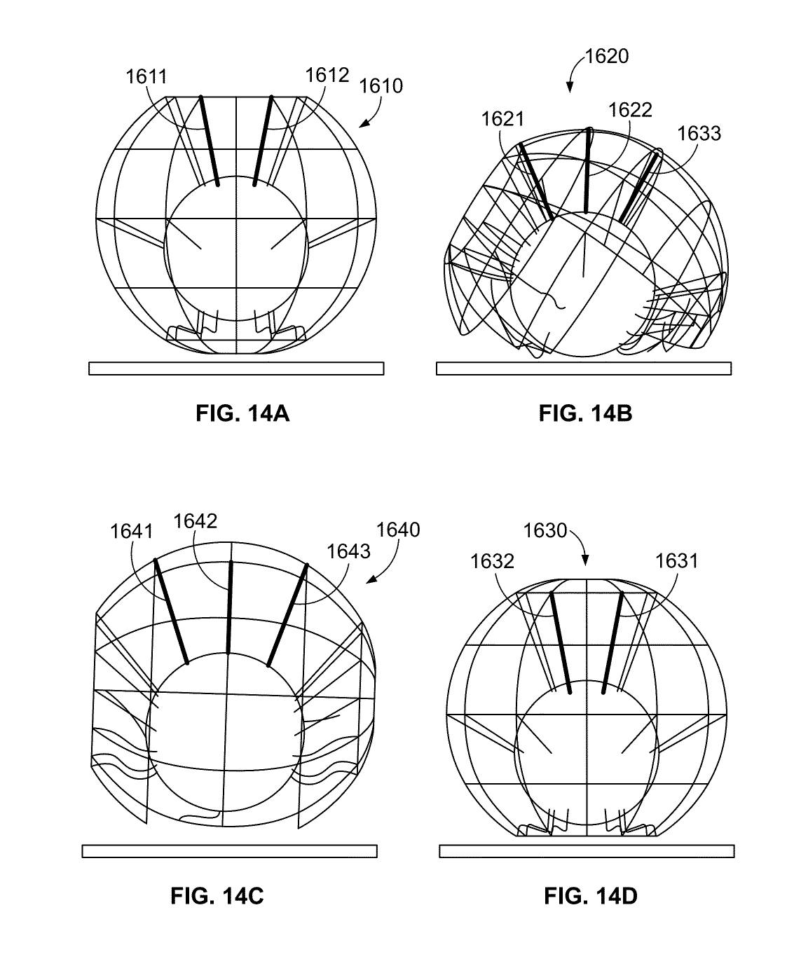

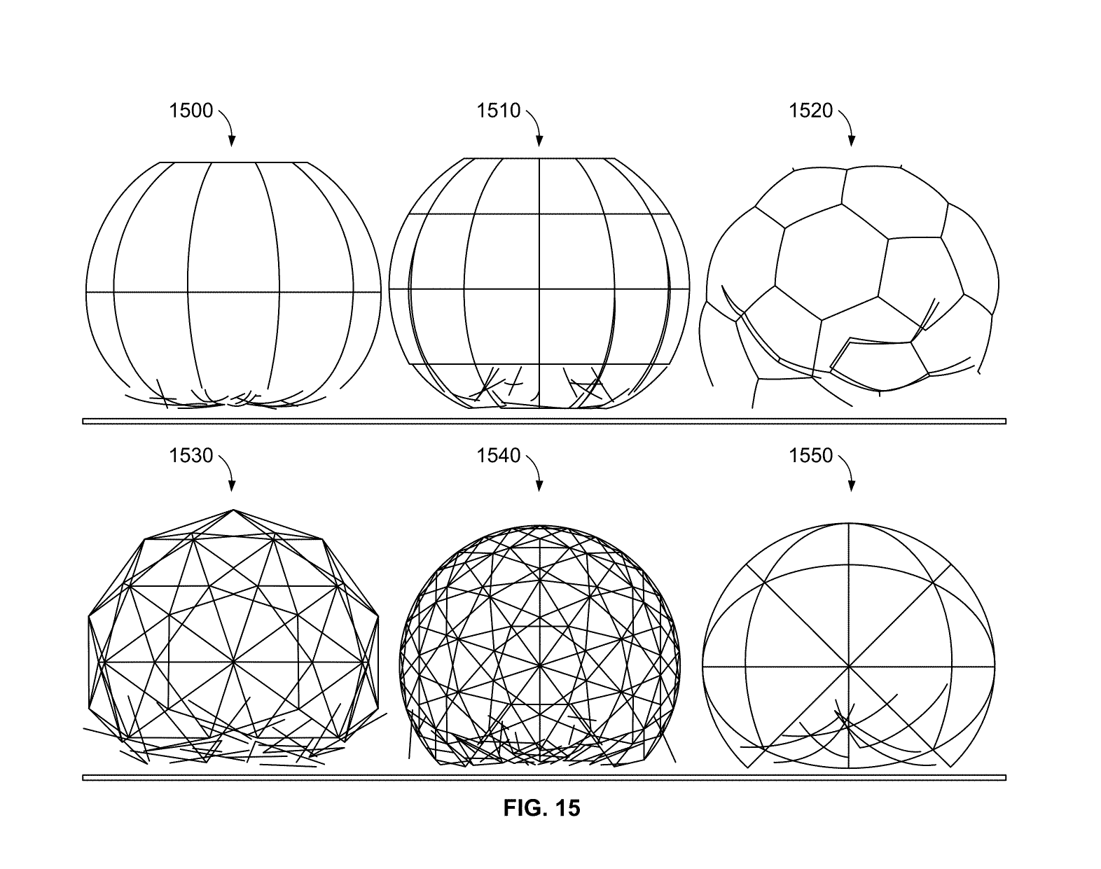

FIGS. 14 and 15 illustrate other embodiments of the present invention. FIG. 14B illustrates that cage 1620 may also be configured to deform upon impact to absorb impact forces. FIG. 15 illustrates the various designs of a spherical cage that may be used. These include, but are not limited to, hoop-ring 1500, a modified hoop ring 1510 as described above with a plurality of vertical and horizontal rings, a truncated icosahedron 1520, geodesics 1530 and 1540, and continuous hoop 1550.

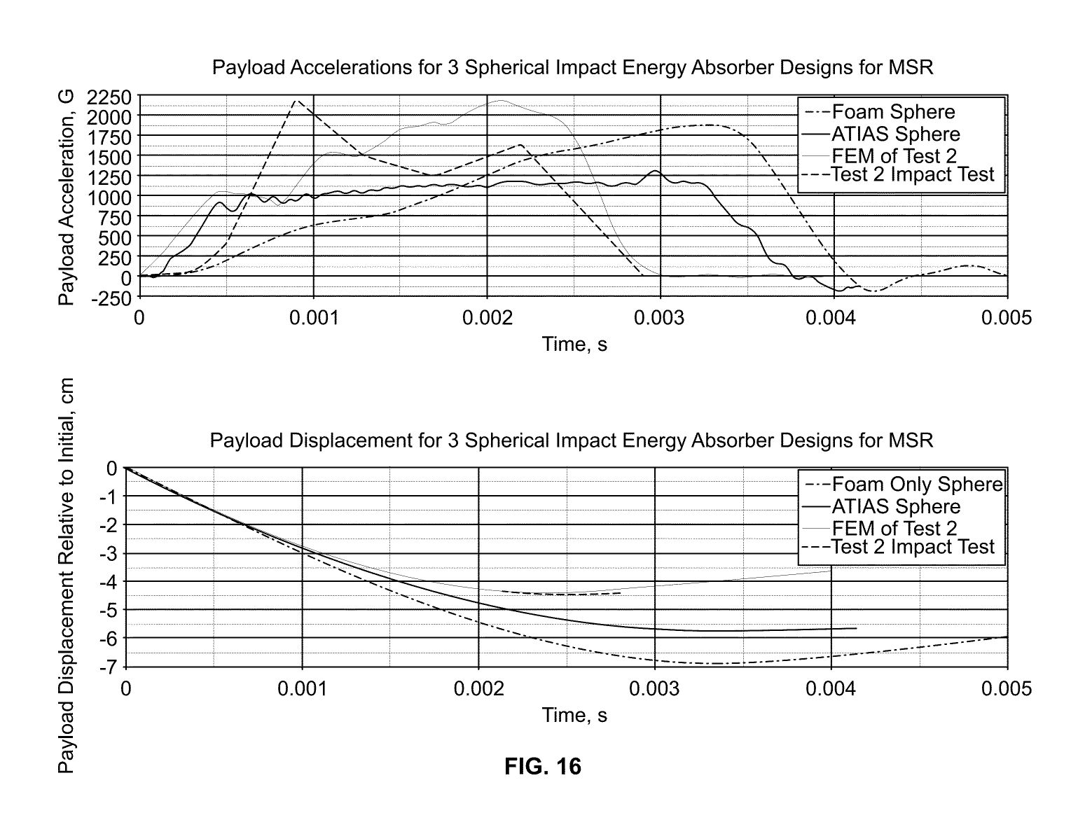

In another embodiment, for any impact angle of the EA, a plurality of cords rearward of the impact point are engaged to average out the impact forces over time to create a flat peak load. As shown in FIG. 14A, at an impact angle of zero, at least cords 1611 and 1612 of EA 1610 average out the impact forces over time to create a flat peak load. As shown in FIG. 14B, at an impact angle of 45 degrees, at least cords 1621, 1622 and 1633 of EA 1620 average out the impact forces over time to create a flat peak load. As shown in FIG. 14C, at an impact angle of 90 degrees, at least cords 1641 and 1642 of EA 1640 average out the impact forces over time to create a flat peak load. As shown in FIG. 14D, at an impact angle of 180 degrees, at least cords 1631 and 1632 of EA 1630 average out the impact forces over time to create a flat peak load. As shown in FIG. 16, for the ATIA Sphere, the engaged cords are shown to have averaged out the impact forces over time to create a flat peak load. This flat response lowers the peak load on the EA by averaging out the impact load over time as compared to response of the Foam Sphere.

In another embodiment of the present invention providing 3 and 4 hoop configurations, cord arrangements with cord angles beginning between 30-40 degrees offer the lowest peak accelerations and the most consistent response across the impact-orientation range. Additionally, a performance trade off exists for using rods and cords. Rods which have buckling response are able to make use of the cord mass on the impact side for energy absorption. Because of this, the configurations that employ rods tend to offer better overall impact performance. As a result, both may be used effectively with solid rods offering higher specific energy absorption in certain applications.

In yet another embodiment of the present invention, as shown in FIGS. 3, and 14A-14D, for all angles or orientations of impact of the energy absorber, at least two cords are activated at impact. In a preferred embodiment, the at least two cords are arranged so that the at least two cords are rearward of the impact point and deform in response to the impact. In yet other embodiments, the at least two cords are arranged so that the at least two cords are rearward of the impact point and the at least two cords form angles that range from 0-60 degrees with respect to the Y-axis that extends from the impact point through the energy absorber for all impact angles or orientations of the energy absorber. In yet other embodiments, the at least two cords are arranged so that the at least two cords are rearward of the impact point and the at least two cords form angles that range from 30-45 degrees with respect to the Y-axis that extends from the impact point through the energy absorber for all impact angles or orientations of the energy absorber.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed is:

1. An energy absorber for absorbing an impact force comprising:
a first housing defining an interior space;
a second housing disposed in said interior space of said first housing;
said second housing adapted to hold an object;
a plurality of cords connecting said first housing to said second housing, said cords adapted to retain said second housing in a pre-impact position where said second housing is maintained in a fixed location in said interior space of said first housing; and
said cords adapted to deform when said energy absorber undergoes an impact, said deformation permits said second housing to travel from said pre-impact position to a post-impact position within said interior space for a predetermined stroke length.

2. The energy absorber of claim 1 wherein said stroke length has a length that prevents said second housing from contacting said first housing.

3. The energy absorber of claim 1 wherein said deformation elongates some of the cords.

4. The energy absorber of claim 1 wherein said deformation compresses some of the cords.

5. The energy absorber of claim 1 wherein said deformation compresses some of the cords and elongates some of the cords.

6. The energy absorber of claim 6 wherein said cords are pretensioned to create compressive forces in said first housing creating a rigid assembly comprising said first housing, said second housing and said cords wherein said second housing is maintained in a fixed location in said interior space of said first housing.

7. The energy absorber of claim 6 wherein said first housing is a spherical cage and said second housing is spherical in shape.

8. The energy absorber of claim 7 wherein on impact of said energy absorber, said cords subjected to compression buckle and said cords subjected to tension elongate and plastically deform.

9. The energy absorber of claim 8 wherein the net impact resisting force of said cords is a flat plateau shaped acceleration response that occurs after impact and before said energy absorber comes to rest.

10. The energy absorber of claim 7 wherein said cords are pretensioned to near their yield strength.

11. The energy absorber of claim 6 wherein said cords are positioned around said second housing so that at least two cords elongate in response to an impact.

12. The energy absorber of claim 11 wherein said at least two cords arranged so that said at least two cords are rearward of the impact point and said at least two cords form angles that range from 0-60 degrees with respect to a Y-axis that extends from the impact point through said energy absorber for all impact angles or orientations of said energy absorber.

13. The energy absorber of claim 12 wherein said spherical cage is comprised of a plurality of intersecting hoops forming a plurality of junctions and said cords extend from said junctions to said second housing.

14. The energy absorber of claim 13 wherein said energy absorber is an earth entry vehicle.

15. The energy absorber of claim 6 wherein said second housing is a piston and said piston travels in said interior space of said first housing when absorbing an impact force.

16. An energy absorbing helmet comprising:
a first shell defining an interior space;
a second shell disposed in said interior space of said first shell;
said second shell adapted to receive an object;
a plurality of cords connecting said first shell to said second shell, said cords adapted to retain said second shell in a pre-impact position where said second shell is maintained in a fixed location in said interior space of said first shell; and
said cords adapted to deform when said helmet undergoes an impact.

17. The energy absorber of claim 16 wherein said cords are pretensioned to create compressive forces in said first shell creating a rigid assembly comprising said first shell, said second shell and said cords wherein said second shell is maintained in a fixed location in said interior space of said first shell.

18. The energy absorber of claim 17 wherein the net impact resisting force of said cords is a flat plateau shaped acceleration response that occurs after impact and before said helmet comes to rest.

19. The energy absorber of claim 6 wherein said cords average out the impact forces over time to create a flat peak load.

20. A method of protecting an object from an impact force comprising:
providing a first housing defining an interior space;
locating a second housing in said interior space of said first housing and using a plurality of cords to connect said housings together;
locating an object to be protected in said second housing;
tensioning said cords to create a compressive force in said first housing;
configuring said cords to deform during impact to average out the impact forces over time to create a flat peak load; and
said deformation of said cords permits said second housing to travel from a pre-impact position to a post-impact position within said interior space up to a maximum predetermined stroke length.
